(19) United States
(12) Patent Application Publication
(10) Pub. No.: US 2018/0141857 A1
(43) Pub. Date: May 24, 2018

(54) STRENGTHENED GLASS PLATE PRODUCING METHOD, GLASS PLATE FOR STRENGTHENING, AND STRENGTHENED GLASS PLATE

(71) Applicant: Nippon Electric Glass Co., Ltd., Shiga (JP)

(72) Inventor: Toru SAKURABAYASHI, Shiga (JP)

(73) Assignee: Nippon Electric Glass Co., Ltd., Shiga (JP)

(21) Appl. No.: 15/572,977

(22) PCT Filed: Apr. 20, 2016
(86) PCT No.: PCT/JP2016/062542

§ 371 Date: Nov. 9, 2017

(30) Foreign Application Priority Data
May 15, 2015 (JP) 2015-099773

(51) Int. Cl. C03C 21/00; C03B 5/225; C03B 17/06

(52) U.S. Cl. CPC C03C 21/002; C03B 17/064; C03B 5/225

(57) ABSTRACT

A technical object of the present invention is to devise a method in which minute foreign matter of a platinum group element is less liable to be generated when a Na₂O-containing glass having high viscosity at high temperature is formed into a sheet shape by an overflow down-draw method. In order to achieve the above-mentioned technical object, a method of manufacturing a tempered glass sheet of the present invention includes: a melting step of melting a glass batch in a melting furnace to provide a molten glass; a fining step of fining the molten glass at a highest temperature of from 1,450° C. to 1,680° C. with a fining vessel formed of a Pt—Rh alloy; a forming step of forming the molten glass into a sheet shape by an overflow down-draw method through use of an alumina-based forming body to provide a glass sheet to be tempered; and an ion exchange treatment step of subjecting the glass sheet to be tempered to ion exchange treatment to provide a tempered glass sheet having a compressive stress layer in a surface.

### TECHNICAL FIELD

The present invention relates to a method of manufacturing a tempered glass sheet, a glass sheet to be tempered, and a tempered glass sheet, and more particularly, to a method of manufacturing a tempered glass sheet, a glass sheet to be tempered, and a tempered glass sheet suitable for a cover glass of a cellular phone, a digital camera, a personal digital assistant (PDA), or a touch panel display.

### BACKGROUND ART

Electronic devices, such as a cellular phone (in particular, a smartphone), a digital camera, a PDA, a touch panel display, and a large-screen television, show a tendency of further prevalence.

In those applications, a tempered glass sheet obtained through ion exchange treatment has been used as a cover glass (see Patent Literature 1 and Non Patent Literature 1). Further, in recent years, the use of the tempered glass sheet in exterior components of a digital signage, a mouse, a smartphone, and the like is increasing.

### CITATION LIST

### Patent Literature

Patent Literature 1: JP 2006-83045 A
Patent Literature 2: JP 2011-133800 A

### Non Patent Literature

Non Patent Literature 1: Tetsuro Izumitani et al., “New glass and physical properties thereof,” First edition, Management System Laboratory. Co., Ltd., Aug. 20, 1984, p. 451-498

### SUMMARY OF INVENTION

### Technical Problem

Meanwhile, a Na₂O-containing glass is used in the tempered glass sheet. The Na₂O-containing glass generally has a viscosity at high temperature lower than that of an alkali-free glass. However, when an attempt is made to increase ion exchange performance of the Na₂O-containing glass, it is necessary to increase the content of Al₂O₃ in a glass composition. In this case, the viscosity at high temperature of the Na₂O-containing glass increases to the same degree as that of the alkali-free glass.

When a glass having high viscosity at high temperature is industrially manufactured, a glass batch obtained by blending various glass raw materials is melt, fined, and homogenized, and then the resultant molten glass is supplied to a forming device to be formed into a desired shape. For a fining vessel, a supply vessel, and the like, a Pt—Rh alloy having high strength and high heat resistance is generally used.

Further, when high quality is required as in a cover glass of a touch panel display, the molten glass is formed into a sheet shape by an overflow down-draw method in order to increase surface smoothness. As a forming body in the overflow down-draw method, a zircon-based refractory is generally used.

However, the Na₂O-containing glass having high viscosity at high temperature is formed into a sheet shape by the overflow down-draw method, minute foreign matter of a platinum group element, in particular, Rh, which has not been generated before, is liable to be generated. The minute foreign matter has a size of 25 μm or less. Therefore, the minute foreign matter does not cause, for example, swelling of a glass surface and does not directly lead to defects of an electronic device. However, when the number of pieces of minute foreign matter increases, there is a risk in that the inspection cost of a glass sheet may increase, and the transmittance and breakage strength of the glass sheet may lower.

In view of the foregoing, the present invention has been made in view of the above-mentioned circumstances, and a technical object of the present invention is to devise a method in which minute foreign matter of a platinum group element is less liable to be generated when a Na₂O-containing glass having high viscosity at high temperature is formed into a sheet shape by an overflow down-draw method.

### Solution to Problem

The inventor of the present invention has made extensive investigations, and as a result, has found that the above-mentioned technical object can be achieved by controlling the highest temperature of a fining vessel within a predetermined range and using an alumina-based forming body as a forming body. The finding is proposed as the present invention. That is, according to one embodiment of the present invention, there is provided a method of manufacturing a tempered glass sheet, comprising: a melting step of melting a glass batch in a melting furnace to provide a molten glass; a fining step of fining the molten glass at a highest temperature of from 1,450° C. to 1,680° C. with a fining vessel formed of a Pt—Rh alloy; a forming step of forming the molten glass into a sheet shape by an overflow down-draw method through use of an alumina-based forming body to provide a glass sheet to be tempered; and an ion exchange treatment step of subjecting the glass sheet to be tempered to ion exchange treatment to provide a tempered glass sheet having a compressive stress layer in a surface. Herein, the “vessel” may have any shape as long as the vessel is capable of accommodating the molten glass. The “vessel” also encompasses, for example, one having a pipe shape and one having a shape with an opening in an upper portion. The “alumina-based forming body” refers to a forming body containing Al₂O₃ at a content of 90 mass % or more. The “Pt—Rh alloy” refers to an alloy containing Pt and Rh at a total content of 99 mass % or more.

The inventor of the present invention considers that the minute foreign matter of a platinum group element increases as described below. First, a platinum group element, such as Pt or Rh, is eluted into the molten glass from the fining vessel kept at high temperature in order to fine bubbles, and the ion concentration of the platinum group element in the molten glass increases. Further, ZrO₂ is eluted from a refractory, a forming body, or the like of the melting furnace to generate a heterogeneous glass containing ZrO₂ at a high concentration. Then, when the heterogeneous glass containing ZrO₂ at a high concentration is mixed with the molten glass in a stirring vessel and the forming body, the solubility of the platinum group element locally lowers when the molten glass flowing down from the forming body is drawn, with the result that the platinum group element deposits as minute metal foreign matter.

In view of the foregoing, in the method of manufacturing a tempered glass sheet according to the embodiment of the present invention, the highest temperature of the fining vessel formed of a Pt—Rh alloy is controlled to 1,680° C. or less, and the alumina-based forming body is used as the forming body, in consideration of the above-mentioned phenomenon. With this, both the elution amount of the platinum group element and the elution amount of ZrO₂ into the molten glass are reduced, and hence the deposition of the minute foreign matter of the platinum group element during forming can be reduced to the extent possible. In a glass manufacturing process, the temperature reaches a maximum in the fining step. Therefore, when the highest temperature in the fining step is controlled, the elution amount of the platinum group element can be controlled properly.

Secondly, it is preferred that in the method of manufacturing a tempered glass sheet according to the embodiment of the present invention, an elution amount of ZrO₂ into the molten glass be controlled to from 10 ppm to 3,000 ppm (by mass) and an elution amount of Rh into the molten glass be controlled to from 0.01 ppm to 5 ppm (by mass).

Thirdly, it is preferred that in the method of manufacturing a tempered glass sheet according to the embodiment of the present invention, a number of pieces of minute foreign matter of a platinum group element in the tempered glass sheet be controlled to 500 pieces/kg or less. Herein, the “minute foreign matter” refers to foreign matter having a maximum diameter of from 0.1 μm to 25 μm.

Fourthly, it is preferred that in the method of manufacturing a tempered glass sheet according to the embodiment of the present invention, the glass batch be produced so as to provide a glass sheet to be tempered comprising as a glass composition, in terms of mass %, 50% to 80% of SiO₂, 10% to 25% of Al₂O₃, 0% to 15% of B₂O₃, 10% to 20% of Na₂O, and 0% to 10% of K₂O.

Fifthly, it is preferred that in the method of manufacturing a tempered glass sheet according to the embodiment of the present invention, the glass batch be produced so as to provide a glass sheet to be tempered having a temperature at a viscosity at high temperature of 10^{2.5} dPa·s of 1,550° C. or more. Herein, the “temperature at a viscosity at high temperature of 10^{2.5} dPa·s” refers to a value obtained through measurement using a platinum sphere pull up method.

Sixthly, according to one embodiment of the present invention, there is provided a glass sheet to be tempered to be subjected to ion exchange treatment, which is formed by an overflow down-draw method and which comprises ZrO₂ at a content of from 10 ppm to 3,000 ppm (by mass) and Rh at a content of from 0.01 ppm to 5 ppm (by mass).

Seventhly, according to one embodiment of the present invention, there is provided a tempered glass sheet having a compressive stress layer in a surface, which is formed by an overflow down-draw method and which comprises ZrO₂ at a content of from 10 ppm to 3,000 ppm (by mass) and Rh at a content of from 0.01 ppm to 5 ppm (by mass).

### DESCRIPTION OF EMBODIMENTS

A glass manufacturing process of a tempered glass sheet generally comprises a melting step, a fining step, a supply step, a stirring step, a forming step, and an ion exchange treatment step. The melting step is a step of melting a glass batch obtained by blending glass raw materials to provide a molten glass. The fining step is a step of fining the molten glass obtained in the melting step by action of a fining agent or the like. The supply step is a step of transferring the molten glass from one step to another. The stirring step is a step of stirring the molten glass to homogenize the molten glass. The forming step is a step of forming the molten glass into a sheet shape. The ion exchange treatment step is a step of forming a compressive stress layer in a glass surface through ion exchange. As necessary, a step other than the above-mentioned steps, for example, a state regulating step involving regulating the molten glass into a state suitable for forming may be inserted after the stirring step. Now, a method of manufacturing a tempered glass sheet of the present invention is described in detail in accordance with each step.

The method of manufacturing a tempered glass sheet of the present invention comprises a melting step of melting a glass batch in a melting furnace to provide a molten glass. The melting step is described below in detail. First, glass raw materials serving as introduction sources of components are blended and mixed so as to achieve a desired glass composition, to thereby produce a glass batch. As necessary, glass cullet may be used as the glass raw materials. The glass cullet refers to glass scraps discharged during the glass manufacturing process and the like. There is no particular limitation on a method of mixing the glass raw materials, and it is only necessary that the method be selected appropriately in accordance with the mass to be mixed in one mixing and the kinds of the glass raw materials. There are given methods of mixing the glass raw materials through use of, for example, a pan-type mixer and a rotary mixer.

Then, the resultant glass batch is loaded into the melting furnace. The glass batch is generally loaded into the melting furnace continuously with a raw material feeder, for example, a screw charger, but the glass batch may be loaded intermittently.

The glass batch loaded into the melting furnace is heated, for example, in a burning atmosphere of a burner or the like or with an electrode installed in the melting furnace to provide the molten glass.

It is preferred that a refractory of the melting furnace be electrocast brick made of ZrO₂ from the viewpoints of heat resistance and suppression of ZrO₂ elution.

It is preferred that the glass batch be produced so as to provide a glass sheet to be tempered comprising as a glass composition, in terms of mass %, 50% to 80% of SiO₂, 10% to 25% of Al₂O₃, 0% to 15% of B₂O₃, 10% to 20% of Na₂O, and 0% to 10% of K₂O. The reason why the content range of each component is limited as described above is described below. The expression “%” refers to “mass %” in the following description of the content range of each component.

SiO₂ is a component which forms a network of a glass. The content of SiO₂ is preferably from 50% to 80%, from 53% to 75%, from 56% to 70%, or from 58% to 68%, particularly preferably from 59% to 65%. When the content of SiO₂ is too small, vitrification does not occur easily. Further, the thermal expansion coefficient becomes too high, and the thermal shock resistance is liable to lower. Meanwhile, when the content of SiO₂ is too large, meltability and formability are liable to lower.

Al₂O₃ is a component which increases ion exchange performance, and is also a component which increases a strain point and a Young's modulus. The content of Al₂O₃ is preferably from 10% to 25%. When the content of Al₂O₃ is too small, the thermal expansion coefficient becomes too high, and the thermal shock resistance is liable to lower. In addition, sufficient ion exchange performance may not be exhibited. Thus, the lower limit range of Al₂O₃ is preferably 12% or more, 14% or more, or 15% or more, particularly preferably 16% or more. Meanwhile, when the content of Al₂O₃ is too large, a devitrified crystal is liable to deposit in the glass and it becomes difficult to form the glass by an overflow down-draw method, or the like. Further, a viscosity at high temperature increases, and the meltability and the formability are liable to lower. Thus, the upper limit range of Al₂O₃ is preferably 22% or less or 20% or less, particularly preferably 19% or less.

B₂O₃ is a component which lowers the viscosity at high temperature and a density, and stabilizes the glass to make it difficult for a crystal to deposit and lowers a liquidus temperature. Further, B₂O₃ is a component which increases crack resistance. However, when the content of B₂O₃ is too large, there are tendencies that the coloring of a surface called weathering occurs due to ion exchange treatment, water resistance lowers, the compressive stress of a compressive stress layer lowers, and the depth of layer of the compressive stress layer lowers. Thus, the content of B₂O₃ is preferably from 0% to 15%, from 0.1% to 12%, from 1% to 10%, from more than 1% to 8%, or from 1.5% to 6%, particularly preferably from 2% to 5%.

Na₂O is a main ion exchange component, and is also a component which lowers the viscosity at high temperature to increase the meltability and the formability. Further, Na₂O is also a component which improves devitrification resistance. The content of Na₂O is preferably from 10% to 20%. When the content of Na₂O is too small, the meltability lowers, the thermal expansion coefficient becomes low, and the ion exchange performance is liable to lower. Thus, the lower limit range of Na₂O is preferably 11% or more, particularly preferably 12% or more. Meanwhile, when the content of Na₂O is too large, the thermal expansion coefficient becomes too high, with the result that the thermal shock resistance lowers and it becomes difficult to match the thermal expansion coefficient with those of peripheral materials. Further, in some cases, the strain point excessively lowers, and the glass composition loses its component balance, with the result that the devitrification resistance lowers contrarily. Thus, the upper limit range of Na₂O is preferably 17% or less, particularly preferably 16% or less.

K₂O is a component which promotes ion exchange, and has a high effect of increasing the depth of layer of the compressive stress layer among alkali metal oxides. Further, K₂O is a component which lowers the viscosity at high temperature to increase the meltability and the formability. Further, K₂O is also a component which improves the devitrification resistance. The content of K₂O is preferably from 0% to 10%. When the content of K₂O is too large, the thermal expansion coefficient becomes too high, with the result that the thermal shock resistance lowers and it becomes difficult to match the thermal expansion coefficient with those of peripheral materials. Further, there are tendencies that the strain point excessively lowers, and the glass composition loses its component balance, with the result that the devitrification resistance lowers contrarily. Thus, the upper limit range of K₂O is preferably 8% or less, 6% or less, or 4% or less, particularly preferably less than 2%.

In addition to the components described above, for example, the following components may be added.

Li₂O is an ion exchange component, and is also a component which lowers the viscosity at high temperature to increase the meltability and the formability. Further, Li₂O is a component which increases the Young's modulus. Further, Li₂O has a high effect of increasing the compressive stress among alkali metal oxides. However, when the content of Li₂O is too large, a liquidus viscosity lowers and the glass is liable to be devitrified. Further, there is a risk in that Li₂O may be eluted during ion exchange treatment to degrade an ion exchange solution. Thus, the content of Li₂O is preferably from 0% to 3.5%, from 0% to 2%, from 0% to 1%, or from 0% to 0.5%, particularly preferably from 0.01% to 0.2%.

MgO is a component which lowers the viscosity at high temperature to increase the meltability and the formability, or to increase the strain point and the Young's modulus, and has a high effect of increasing the ion exchange performance among alkaline earth metal oxides. However, when the content of MgO is too large, the density and the thermal expansion coefficient are liable to increase, and the glass is liable to be devitrified. Thus, the upper limit range of MgO is preferably 12% or less, 10% or less, 8% or less, or 5% or less, particularly preferably 4% or less. When MgO is introduced into the glass composition, the lower limit range of MgO is preferably 0.1% or more, 0.5% or more, or 1% or more, particularly preferably 2% or more.

CaO has a high effect of lowering the viscosity at high temperature to increase the meltability and the formability or to increase the strain point and the Young's modulus, without lowering the devitrification resistance as compared to the other components. The content of CaO is preferably from 0% to 10%. However, when the content of CaO is too large, the density and the thermal expansion coefficient increase, and the ion exchange performance is liable to lower. Thus, the content of CaO is preferably from 0% to 5%, particularly preferably from 0% to less than 1%.

SnO₂ is a component which exhibits a fining effect in a high temperature range but accelerates the deposition of minute foreign matter of Rh. The content range thereof is preferably from 500 ppm to 10,000 ppm (from 0.05% to 1%), particularly preferably from 1,000 ppm to 7,000 ppm.

As a fining agent, one kind or two or more kinds selected from the group consisting of As₂O₃, Sb₂O₃, F, Cl, and SO₃ may be introduced at a content of from 0 ppm to 10,000 ppm (1%).

Further, it is preferred that the glass batch be produced so as to provide a glass sheet to be tempered having a temperature at a viscosity at high temperature of 10^{2.5} dPa·s of 1,520° C. or more (preferably 1,550° C. or more, particularly preferably 1,570° C. or more). As the temperature at a viscosity at high temperature of 10^{2.5} dPa·s becomes higher, the meltability and the formability are less liable to lower. Meanwhile, the allowable addition amount of Al₂O₃ and the like can be increased, and hence the ion exchange performance of the glass sheet to be tempered can improve easily. Further, as the temperature at a viscosity at high temperature of 10^{2.5} dPa·s becomes higher, the temperature of the glass manufacturing process increases, and the platinum group element and ZrO₂ are liable to be eluted into the molten glass. Therefore, the effects of the invention of the present application increase relatively.

The method of manufacturing a tempered glass sheet of the present invention comprises a fining step of fining the molten glass at a highest temperature of from 1,450° C. to 1,640° C. with a fining vessel formed of a Pt—Rh alloy. The Pt—Rh alloy is inactive with respect to the molten glass and has satisfactory heat resistance and mechanical strength. However, the Pt—Rh alloy is corroded with the molten glass to be eluted into the molten glass depending on the temperature condition, the usage environment, and the like. In view of the foregoing, the highest temperature in the fining step is controlled to from 1,450° C. to 1,680° C., preferably from 1,480° C. to 1,640° C. or from 1,500° C. to 1,620° C., particularly preferably from 1,550° C. to 1,600° C. When the highest temperature in the fining step is excessively high, the elution amount of the platinum group element increases excessively. Meanwhile, when the highest temperature in the fining step is excessively low, a fining property becomes insufficient, and bubbles are liable to remain in the glass sheet to be tempered.

It is preferred that the method of manufacturing a tempered glass sheet of the present invention comprise a supply step of supplying the molten glass with a supply vessel formed of a Pt—Rh alloy. The temperature in the supply step becomes high, and hence there is a concern about elution of the platinum group element. Thus, the highest temperature in the supply step is preferably 1,640° C. or less, more preferably 1,600° C. or less, particularly preferably from 1,450° C. to 1,580° C. When the highest temperature in the supply step is excessively high, the elution amount of the platinum group element is liable to increase.

It is preferred that the method of manufacturing a tempered glass sheet of the present invention comprise a stirring step of stirring the molten glass with a stirring vessel formed of a Pt—Rh alloy. The temperature in the stirring step becomes high, and hence there is a concern about elution of the platinum group element. Thus, the highest temperature in the stirring step is preferably 1,640° C. or less, more preferably 1,600° C. or less, particularly preferably from 1,450° C. to 1,580° C. When the highest temperature in the stirring step is excessively high, the elution amount of the platinum group element is liable to increase.

The method of manufacturing a tempered glass sheet of the present invention comprises a forming step of forming the molten glass into a sheet shape by an overflow down-draw method through use of an alumina-based forming body to provide the glass sheet to be tempered. The alumina-based forming body has features of high heat resistance and less deformation even at high temperature. The alumina-based forming body also has a feature that ZrO₂ is less liable to be eluted during forming by virtue of a small content of ZrO₂. Further, the alumina-based forming body has low reactivity with respect to the molten glass, and hence devitrified foreign matter is less liable to be generated during forming.

The overflow down-draw method refers to a method involving causing a molten glass to overflow from both sides of a heat-resistant trough-shaped structure, and subjecting the overflowing molten glasses to down-draw downward while the molten glasses are joined at the lower tip end of the trough-shaped structure, to thereby form a sheet shape. In the overflow down-draw method, a surface to serve as the surface of the glass sheet is not brought into contact with a trough-shaped refractory, and is formed in a state of a free surface. Thus, the glass sheet to be tempered having high surface smoothness is produced easily.

In the forming step, it is preferred that the molten glass be formed so that the thickness of the glass sheet to be tempered is preferably 1.5 mm or less, 1.0 mm or less, 0.8 mm or less, or 0.7 mm or less, particularly preferably from 0.2 mm to 0.6 mm. When the thickness is set to be thin, the weight of an electronic device can be reduced easily.

In the method of manufacturing a tempered glass sheet of the present invention, it is preferred that the number of pieces of minute foreign matter of the platinum group element in the glass sheet to be tempered (tempered glass sheet) be controlled to 500 pieces/kg or less or 400 pieces/kg or less, particularly from 10 kg/piece to 300 kg/piece. When the number of pieces of minute foreign matter is large, there is a risk in that the inspection cost of the glass sheet may be increased, and a transmittance and breakage strength of the glass sheet may lower.

Further, it is preferred that the elution amount of ZrO₂ into the molten glass be controlled to from 10 ppm to 3,000 ppm (by mass) and the elution amount of Rh into the molten glass be controlled to from 0.01 ppm to 5 ppm (by mass).

ZrO₂ is a component which dramatically improves the ion exchange performance and increases a viscosity around the liquidus viscosity and the strain point. However, ZrO₂ is a component which accelerates the deposition of minute foreign matter of the platinum group element during forming. Thus, the upper limit range of ZrO₂ is preferably 3,000 ppm or less (0.3% or less), 2,000 ppm or less, 1,500 ppm or less, 1,200 ppm or less, or 1,000 ppm or less, particularly preferably 600 ppm or less. Meanwhile, when the content (elution amount) of ZrO₂ is controlled to be excessively low, it becomes difficult to manage impurities, and moreover, it becomes difficult to use brick made of ZrO₂ as the refractory of the melting furnace. Thus, in consideration of the production efficiency of the glass sheet to be tempered, the lower limit range of ZrO₂ is preferably 10 ppm or more or 50 ppm or more, particularly preferably 100 ppm or more.

The content (elution amount) of Rh is preferably 5 ppm or less (0.0005% or less), 1 ppm or less, or 0.5 ppm or less, particularly preferably 0.2 ppm or less. When the content of Rh is excessively large, minute foreign matter of Rh is liable to deposit during forming. Meanwhile, when the content of Rh is controlled to be excessively small, it becomes difficult to manage impurities, and moreover, it becomes difficult to use the Pt—Rh alloy for the fining vessel, the supply vessel, and the like. Thus, in consideration of the production efficiently of the glass sheet to be tempered, the lower limit range of Rh is preferably 0.01 ppm or more, particularly preferably 0.03 ppm or more.

The method of manufacturing a tempered glass sheet of the present invention comprises an ion exchange treatment step of subjecting the glass sheet to be tempered to ion exchange treatment to provide a tempered glass sheet having a compressive stress layer in a surface. The ion exchange treatment is a method involving introducing an alkali ion having a large ionic radius into a glass surface at a temperature equal to or lower than the strain point of the glass sheet to be tempered. With this, even when the thickness of the glass sheet to be tempered is small, the compressive stress layer can be formed properly.

It is appropriate that the composition of an ion exchange solution, an ion exchange temperature, and an ion exchange time be determined in consideration of, for example, viscosity characteristics of the glass sheet to be tempered. As the ion exchange solution, various ion exchange solutions may be used, but a KNO₃ molten salt or a mixed molten salt of NaNO₃ and KNO₃ is preferred. With this, the compressive stress layer can be formed efficiently in the surface. The ion exchange temperature is preferably from 380° C. to 460° C., and the ion exchange time is preferably from 2 hours to 8 hours. With this, the compressive stress layer can be formed properly.

A compressive stress of the compressive stress layer formed through ion exchange treatment is preferably 400 MPa or more, 500 MPa or more, 600 MPa or more, or 650 MPa or more, particularly preferably from 700 MPa to 1,500 MPa. As the compressive stress becomes larger, the mechanical strength of the tempered glass sheet increases.

A depth of layer of the compressive stress layer is preferably 15 μm or more, 20 μm or more, or 25 μm or more, particularly preferably from 30 μm to 60 μm. As the depth of layer becomes larger, the tempered glass sheet is less liable to be broken when the tempered glass sheet has a flaw on the surface. Herein, the “compressive stress” and the “depth of layer” refer to values calculated on the basis of the number of interference fringes observed when a sample is observed using a surface stress meter (for example, FSM-6000 manufactured by Toshiba Corporation) and intervals therebetween.

An internal tensile stress is preferably from 10 MPa to 200 MPa or from 15 MPa to 150 MPa, particularly preferably from 20 MPa to 100 MPa. When the internal tensile stress is excessively small, it becomes difficult to ensure desired mechanical strength in the tempered glass sheet. Meanwhile, when the internal tensile stress is excessively large, the tempered glass sheet is liable to be subjected to spontaneous breakage originating from mechanical shock. The internal tensile stress refers to a value calculated by the following expression: (Compressive stress×Depth of layer)/(Thickness of Tempered glass-2×Depth of layer).

The glass sheet may be cut into a predetermined size before the ion exchange treatment step, that is, the glass sheet may be subjected to “cutting before tempering”. However, it is preferred that the tempered glass sheet be cut into a predetermined size after the ion exchange treatment step, that is, it is preferred that the temperature glass sheet be subjected to “cutting after tempering”. With this, the manufacturing efficiency of the tempered glass sheet improves.

The glass sheet to be tempered of the present invention is a glass sheet to be tempered to be subjected to ion exchange treatment, which is formed by an overflow down-draw method and which comprises ZrO₂ at a content of from 10 ppm to 3,000 ppm (by mass) and Rh at a content of from 0.01 ppm to 5 ppm (by mass). Herein, the technical features of the glass to be tempered of the present invention overlap those of the method of manufacturing a tempered glass sheet of the present invention. In this description, the description of the overlapping portion is omitted for convenience.

The tempered glass sheet of the present invention is a tempered glass sheet having a compressive stress layer in a surface, which is formed by an overflow down-draw method and which comprises ZrO₂ at a content of from 10 ppm to 3,000 ppm (by mass) and Rh at a content of from 0.01 ppm to 5 ppm (by mass). Herein, the technical features of the tempered glass of the present invention overlap those of the method of manufacturing a tempered glass sheet of the present invention. In this description, the description of the overlapping portion is omitted for convenience.

### Example 1

The present invention is hereinafter described in detail with reference to Examples. The following Examples are merely illustrative. The present invention is by no means limited to the following Examples.

Glasses to be tempered were produced as described below. First, glass raw materials were blended so as to achieve a glass composition shown in a table, to thereby produce a glass batch. Next, the glass batch was loaded into a continuous melting furnace formed of electrocast brick made of ZrO₂. After that, the resultant molten glass was fined with a vessel made of a Pt—Rh alloy, and stirred and supplied with vessels each made of a Pt—Rh alloy. In this case, the highest temperature in a fining step was controlled as shown in the table. Then, the resultant was formed into a glass sheet to be tempered having dimensions of 1,100 mm×1,250 mm×0.7 mm in thickness by an overflow down-draw method through use of, as a forming body, an alumina-based forming body (content of Al₂O₃: 98 mass %) or a zircon-based forming body. The order of the retention times of the molten glasses in the continuous melting furnace is as follows: (short) Sample Nos. 1, 2, and 8<Sample No. 4<Sample Nos. 3 and 6<Sample Nos. 5 and 7 (long). Further, the highest temperature in an annealing step and the highest temperature in a stirring step are lower than that in the fining step.

TABLE 1

| Glass composition | Example | | | | Comparative Example | | | |
|---|---|---|---|---|---|---|---|---|
| (wt %) | No. 1 | No. 2 | No. 3 | No. 4 | No. 5 | No. 6 | No. 7 | No. 8 |
| SiO₂ | 61.0 | 61.0 | 61.0 | 61.0 | 65.5 | 61.0 | 61.0 | 61.0 |
| Al₂O₃ | 18.0 | 18.0 | 18.0 | 18.5 | 14.0 | 18.0 | 18.0 | 18.0 |
| B₂O₃ | 0.5 | 0.5 | 0.5 | 0.5 | 4.0 | 0.5 | 0.5 | 0.5 |
| Na₂O | 15.0 | 15.0 | 15.0 | 15.0 | 12.0 | 15.0 | 15.0 | 15.0 |
| K₂O | 2.0 | 2.0 | 2.0 | 1.5 | 1.0 | 2.0 | 2.0 | 2.0 |
| MgO | 3.0 | 3.0 | 3.0 | 3.0 | 3.0 | 3.0 | 3.0 | 3.0 |
| SnO₂ | 0.5 | 0.5 | 0.5 | 0.5 | 0.5 | 0.5 | 0.5 | 0.5 |
| ZrO₂ (ppm) | 200 | 300 | 1,000 | 700 | 3,000 | 1,500 | 3,000 | 300 |
| Rh (ppm) | 0.05 | 0.05 | 0.05 | 0.30 | 0.05 | 1.50 | 5.00 | 10.00 |
| Temperature at 10^{2.5} | 1,580 | 1,580 | 1,580 | 1,590 | 1,590 | 1,580 | 1,580 | 1,580 |
| dPa · s (° C.) | | | | | | | | |
| Forming body | Alumina | Alumina | Alumina | Alumina | Zircon | Zircon | Zircon | Alumina |
| Highest temperature in | 1,580 | 1,580 | 1,580 | 1,600 | 1,580 | 1,650 | 1,670 | 1,690 |
| fining step (° C.) | | | | | | | | |
| Number of pieces of | 200 | 300 | 400 | 450 | 750 | 2,500 | 10,000 | 2,000 |
| minute foreign matter | | | | | | | | |
| (pieces/kg) | | | | | | | | |

Next, Sample Nos. 1 to 3 and 6 to 8 were subjected to ion exchange treatment by being immersed in a KNO₃ molten salt (fresh KNO₃ molten salt) at 430° C. for 4 hours. After that, both the surfaces of each sample were washed to provide a tempered glass sheet. Then, a compressive stress CS and a depth of layer DOL of a compressive stress layer in the surface were calculated on the basis of the number of interference fringes observed using a surface stress meter (FSM-6000 manufactured by Toshiba Corporation) and intervals therebetween. As a result, in each sample, the CS was 740 MPa, and the DOL was 32 μm. In the calculation, the refractive index and optical elastic constant of each sample were defined as 1.50 and 30 [(nm/cm)/MPa], respectively.

In each sample, the content of ZrO₂ and the content of Rh were measured. The results thereof are shown in Table 1. The amounts of ZrO₂ and Rh mixed from the glass batch were negligibly small, and it is assumed that the content of ZrO₂ and the content of Rh in the glass sheet to be tempered resulted from their elution during the glass manufacturing process.

Further, in each sample, the number of pieces of minute foreign matter (maximum diameter: from 0.1 μm to 25 μm) of the platinum group element was counted visually under irradiation with an edge light. The results thereof are shown in Table 1. Most of the minute foreign matter was Rh.

In Sample Nos. 1 to 4, the highest temperature in the fining step was low, and the alumina-based forming body was used. Therefore, the number of pieces of minute foreign matter of the platinum group element was small. Meanwhile, in Sample Nos. 5 to 8, the zircon-based forming body was used, and hence the number of pieces of minute foreign matter of the platinum group element was large.

### Example 2

It is considered that, even in tempered glass sheets (Samples a to e) shown in Table 2, the effects similar to the tendency described in the section [Example 1] are obtained.

TABLE 2

| | | a | b | c | d | e |
|---|---|---|---|---|---|---|
| Glass | SiO₂ | 66.00 | 58.80 | 61.70 | 61.19 | 62.40 |
| composition | Al₂O₃ | 14.20 | 21.40 | 19.70 | 16.20 | 12.90 |
| (mass %) | B₂O₃ | 2.30 | 4.90 | 3.60 | 0.80 | 4.45 |
| | Li₂O | 0.10 | 0.00 | 0.00 | 0.00 | 0.10 |
| | Na₂O | 13.40 | 13.10 | 13.20 | 14.10 | 16.00 |
| | K₂O | 0.60 | 0.00 | 0.00 | 3.40 | 2.00 |
| | MgO | 3.00 | 1.50 | 1.50 | 3.60 | 0.00 |
| | CaO | 0.00 | 0.00 | 0.00 | 0.50 | 2.00 |
| | ZrO₂ | 0.00 | 0.10 | 0.10 | 0.01 | 0.05 |
| | SnO₂ | 0.40 | 0.20 | 0.20 | 0.20 | 0.10 |

### INDUSTRIAL APPLICABILITY

The tempered glass sheet of the present invention is suitable for a cover glass of, for example, a cellular phone, a digital camera, a PDA, or a touch panel display. Further, the tempered glass sheet of the present invention can be expected to find use in applications requiring high mechanical strength, for example, a window glass, a substrate for a magnetic disk, a substrate for a flat panel display, and a cover glass for a solid image pick-up element, in addition to the above-mentioned applications.

1. A method of manufacturing a tempered glass sheet, comprising:
a melting step of melting a glass batch in a melting furnace to provide a molten glass;
a fining step of fining the molten glass at a highest temperature of from 1,450° C. to 1,680° C. with a fining vessel formed of a Pt—Rh alloy;
a forming step of forming the molten glass into a sheet shape by an overflow down-draw method through use of an alumina-based forming body to provide a glass sheet to be tempered; and
an ion exchange treatment step of subjecting the glass sheet to be tempered to ion exchange treatment to provide a tempered glass sheet having a compressive stress layer in a surface.

2. The method of manufacturing a tempered glass sheet according to claim 1, wherein an elution amount of ZrO₂ into the molten glass is controlled to from 10 ppm to 3,000 ppm (by mass) and an elution amount of Rh into the molten glass is controlled to from 0.01 ppm to 5 ppm (by mass).

3. The method of manufacturing a tempered glass sheet according to claim 1, wherein a number of pieces of minute foreign matter of a platinum group element in the tempered glass sheet is controlled to 500 pieces/kg or less.

4. The method of manufacturing a tempered glass sheet according to claim 1, wherein the glass batch is produced so as to provide a glass sheet to be tempered comprising as a glass composition, in terms of mass %, 50% to 80% of SiO₂, 10% to 25% of Al₂O₃, 0% to 15% of B₂O₃, 10% to 20% of Na₂O, and 0% to 10% of K₂O.

5. The method of manufacturing a tempered glass sheet according to claim 1, wherein the glass batch is produced so as to provide a glass sheet to be tempered having a temperature at a viscosity at high temperature of 10^{2.5} dPa·s of 1,550° C. or more.

6. A glass sheet to be tempered to be subjected to ion exchange treatment, which is formed by an overflow down-draw method and which comprises ZrO₂ at a content of from 10 ppm to 3,000 ppm (by mass) and Rh at a content of from 0.01 ppm to 5 ppm (by mass).

7. A tempered glass sheet having a compressive stress layer in a surface, which is formed by an overflow down-draw method and which comprises ZrO₂ at a content of from 10 ppm to 3,000 ppm (by mass) and Rh at a content of from 0.01 ppm to 5 ppm (by mass).

8. The method of manufacturing a tempered glass sheet according to claim 2, wherein a number of pieces of minute foreign matter of a platinum group element in the tempered glass sheet is controlled to 500 pieces/kg or less.

9. The method of manufacturing a tempered glass sheet according to claim 2, wherein the glass batch is produced so as to provide a glass sheet to be tempered comprising as a glass composition, in terms of mass %, 50% to 80% of SiO₂, 10% to 25% of Al₂O₃, 0% to 15% of B₂O₃, 10% to 20% of Na₂O, and 0% to 10% of K₂O.

10. The method of manufacturing a tempered glass sheet according to claim 3, wherein the glass batch is produced so as to provide a glass sheet to be tempered comprising as a glass composition, in terms of mass %, 50% to 80% of SiO₂, 10% to 25% of Al₂O₃, 0% to 15% of B₂O₃, 10% to 20% of Na₂O, and 0% to 10% of K₂O.

11. The method of manufacturing a tempered glass sheet according to claim 8, wherein the glass batch is produced so as to provide a glass sheet to be tempered comprising as a glass composition, in terms of mass %, 50% to 80% of SiO₂, 10% to 25% of Al₂O₃, 0% to 15% of B₂O₃, 10% to 20% of Na₂O, and 0% to 10% of K₂O.

12. The method of manufacturing a tempered glass sheet according to claim 2, wherein the glass batch is produced so as to provide a glass sheet to be tempered having a temperature at a viscosity at high temperature of 10^{2.5} dPa·s of 1,550° C. or more.

13. The method of manufacturing a tempered glass sheet according to claim 3, wherein the glass batch is produced so as to provide a glass sheet to be tempered having a temperature at a viscosity at high temperature of 10^{2.5} dPa·s of 1,550° C. or more.

14. The method of manufacturing a tempered glass sheet according to claim 4, wherein the glass batch is produced so as to provide a glass sheet to be tempered having a temperature at a viscosity at high temperature of 10^{2.5} dPa·s of 1,550° C. or more.

15. The method of manufacturing a tempered glass sheet according to claim 8, wherein the glass batch is produced so as to provide a glass sheet to be tempered having a temperature at a viscosity at high temperature of 10^{2.5} dPa·s of 1,550° C. or more.

16. The method of manufacturing a tempered glass sheet according to claim 9, wherein the glass batch is produced so as to provide a glass sheet to be tempered having a temperature at a viscosity at high temperature of 10^{2.5} dPa·s of 1,550° C. or more.

17. The method of manufacturing a tempered glass sheet according to claim 10, wherein the glass batch is produced so as to provide a glass sheet to be tempered having a temperature at a viscosity at high temperature of 10^{2.5} dPa·s of 1,550° C. or more.

18. The method of manufacturing a tempered glass sheet according to claim 11, wherein the glass batch is produced so as to provide a glass sheet to be tempered having a temperature at a viscosity at high temperature of 10^{2.5} dPa·s of 1,550° C. or more.
